(19) United States
(12) Patent Application Publication
(10) Pub. No.: US 2019/0272711 A1
(43) Pub. Date: Sep. 5, 2019

(54) Advertisement System Applicable for Multiple Portable Devices

(71) Applicants: Chien-Jiun Wang, Taoyuan (TW); Yao-Sin Tsai, Hualien County (TW)

(72) Inventors: Chien-Jiun Wang, Taoyuan (TW); Yao-Sin Tsai, Hualien (TW)

(21) Appl. No.: 16/416,110

(22) Filed: May 17, 2019

Related U.S. Application Data
(63) Continuation of application No. 15/393,236, filed on Dec. 28, 2016.

(30) Foreign Application Priority Data
Dec. 29, 2015 (TW) 104144195

(51) Int. Cl. G07F 17/34; G07F 17/32; H04L 29/06

(52) U.S. Cl. CPC G07F 17/34; G07F 17/3239; G07F 17/3237; G07F 17/3225; G07F 17/3216; H04L 65/1089; H04B 1/3827; H04L 65/4069; H04L 65/60; G07F 17/3244; G07F 17/3227; H04L 65/602; G07F 17/3213

(57) ABSTRACT

An advertisement system applicable for multiple portable devices is provided. The system is capable of performing slot machine game method using advertisement data streaming which includes: inputting user raw data of at least one portable device and advertisement data of at least one advertisement provider to a data mining module of a data analyzing module of a remote server to generate selected users and advertisement symbols; a data streaming module streaming the selected advertisement symbols to generate multiple sets of streaming advertisement symbols; matching the selected users with the multiple sets of streaming advertisement symbols in a slot machine generator; and displaying process and outcome of the slot game on a display unit of the portable device.

### CROSS-REFERENCE TO RELATED APPLICATIONS

This patent application is a continuation application of patent application Ser. No. 15/393,236, filed on Dec. 28, 2016, which claims priority from TAIWAN patent application serial number 104144195, filed on Dec. 29, 2015, the disclosure of which is hereby incorporated by reference herein in their entirety.

### TECHNICAL FIELD

The present invention relates to an electronic advertisement system, and particularly to a system for advertisement data streaming.

### BACKGROUND OF RELATED ARTS

Current well-known probability type games include point number game such as dice game, card draw game, slot machine game or roulette game, etc. The player only needs to wager and operate simply (for example pull the handle of the slot machine) and even only needs to wager to complete the game because the operation of the probability type game is very simple. The outcome of the game depends on the probability, and the player needn't spend a lot of time to focus his/her attention on the game and think about it. Thus, the probability type game is often very popular in the playground and sometimes is also employed as a subsidiary game of other games. For instance, the probability type game is utilized in the online game or the table game as a mechanism to decide whether an item can be obtained and an event can be triggered or not, or what kind of item can be acquired and what kind of event can be triggered.

The slot machine games have developed to computer-controlled virtual platform from the traditional mechanical reel type physical machine with the rise of electronic digital products. The operation of pulling the handle of the physical slot machine and the effect of rolling the reels to change the symbol or number arrangement can be simulated by employing the calculation unit, the display unit and the operation unit in the computer. However, regardless of the traditional physical machine or the current virtual platform, when the player is playing the slot machine game, he/she only needs to wager and perform the operation of pulling the handle. Then, the player can only wait the outcome of the game. Most of the procedures of the game are mechanically operated by the physical machine or are computed by the virtual platform, which lacks the operation mechanism to render the player to further join in the game. When the player realizes the fact that the number of times the symbols come out and the relative positions of the symbols in the slot machine are controlled by the developer of the game, the rolling speeds of the reels are limited by the slot machine or the program design, the stop timing is determined by probability and the player's capability of controlling the outcome of the game and the proportion of joining the game are relatively low, the player may easily give up playing the slot machine game, such that the slot machine game cannot attract the players continuously anymore.

In view of the dullness of the traditional slot machine game, the present invention provides a novel slot game system and the method thereof to enhance the attraction of the game and improve the slot game.

### SUMMARY

One object of the present invention is to provide a slot game system using advertisement data streaming. The system may include a remote server, at least one advertisement provider and at least one portable device. The remote server may include a memory, a data analyzing module, a data streaming module, a slot machine generator and a first slot game module. The at least one portable device transmits the user raw data to the remote server through the wireless transmission method. The at least one advertisement provider transmits the advertisement data to the remote server. The portable device may include a second slot game module to display the process and the outcome of the slot game in the first slot game module on the display unit of the portable device.

According to one aspect of the present invention, the remote server may further include a central processing unit coupled to the memory, the data analyzing module, the data streaming module, the slot machine generator and the slot game module.

In one aspect, the user raw data and the advertisement data which are transmitted to the remote server are stored in the memory.

In another aspect, the memory may be coupled to the data analyzing module and the data streaming module, and the slot machine generator may be coupled to the data analyzing module and the data streaming module. The slot machine generator may be coupled to the first slot game module while the first slot game module may be coupled to the portable device.

In still another aspect, a method of slot machine game using advertisement data streaming is provided, including: firstly, inputting a user raw data of at least one portable device to a remote server and storing the user raw data in a memory of the remote server. Then, advertisement data of at least one advertisement provider are inputted to the remote server and are stored in the memory. Subsequently, the user raw data and the advertisement data are inputted to a data mining module of a data analyzing module of the remote server to generate selected users and selected advertisement symbols. Then, the selected users and the selected advertisement symbols are output by the data mining module respectively to a slot machine generator and a data streaming module of the remote server. Subsequently, a message of a series of the selected advertisement symbols is transmitted by the data mining module to the data streaming module, and the selected advertisement symbols are inputted from the memory to the data streaming module. Then, the data streaming module streams the selected advertisement symbols to generate multiple sets of streaming advertisement symbols. Subsequently, the selected users are matched with the multiple sets of streaming advertisement symbols in the slot machine generator according to the selected users output by the data mining module to the slot machine generator and the multiple sets of streaming advertisement symbols output by the data streaming module to the slot machine generator. Finally, a slot game is performed in a slot game module based on a result of the matching, and the process and the outcome of the slot game in the slot game module are displayed on a display unit of the portable device.

In one aspect, each of the streaming advertisement symbols needed by the slot game may include a plurality of different advertisement symbols.

In another aspect, an advertisement data stream generator may stream the selected advertisement symbols to generate multiple sets of streaming advertisement symbols.

In another aspect, the slot game module may be disposed in the remote server to perform the slot game.

In yet another aspect, the portable device may include a second slot game module to display the process and the outcome of the slot game in the slot game module of the remote server on the display unit of the portable device.

An advertisement system applicable for multiple portable devices comprises an advertisement remote server coupled to the multiple portable devices, wherein each of the multiple portable devices having a first wireless transmission module and first internet module. The advertisement remote server includes a second wireless transmission module, a second internet module, a data analyzing module, a data streaming module and a slot machine generator. Multiple user raw data are transmitted by the first wireless transmission modules or the first internet modules of each multiple portable devices to the second wireless transmission module or the second internet module of the advertisement remote server. Multiple advertisement data are transmitted by a plurality of advertisement data transmitting terminals to the advertisement remote server. The data analyzing module is used to generate selected users. The data streaming module is used to generate a plurality of groups of under-streaming advertisement data. The slot machine generator is used to match the selected users with the plurality of groups of under-streaming advertisement data such that each of the selected users corresponds at least one group of under-streaming advertisement data. Each of the multiple portable devices displays streaming data of the at least one group of under-streaming advertisement data on a display unit.

These and other advantages will become apparent from the following description of preferred embodiments and the appended claims.

### BRIEF DESCRIPTION OF THE DRAWINGS

The present invention may be understood by some preferred embodiments and detailed descriptions in the specification and the attached drawings below. However, it should be appreciated that these drawings are only utilized for illustrating the present invention, not for limiting the present invention to one specific embodiment.

FIG. 1 is a functional block diagram of a slot game system using advertisement data streaming in accordance with the present invention.

FIG. 2 is a functional block diagram of a slot game system using advertisement data streaming in accordance with one embodiment of the present invention.

FIG. 3 is a functional block diagram of a portable device in accordance with the present invention.

FIG. 4 is a diagram of three streaming advertisement symbols in accordance with one embodiment of the present invention.

FIG. 5 is a diagram showing the three streaming advertisement symbols in the portable device in accordance with one embodiment of the present invention.

FIG. 6 is a functional block diagram of the slot game system using advertisement data streaming in accordance with another embodiment of the present invention.

### DETAILED DESCRIPTION OF THE PREFERRED EMBODIMENT

The present invention will now be described in detail with the specific embodiments and aspects and these descriptions interpret structure and procedures of the present invention only for illustrating but not for limiting the Claims of the present invention. Therefore, except the specific and preferred embodiments in the specification, the present invention may also be widely performed in other embodiments.

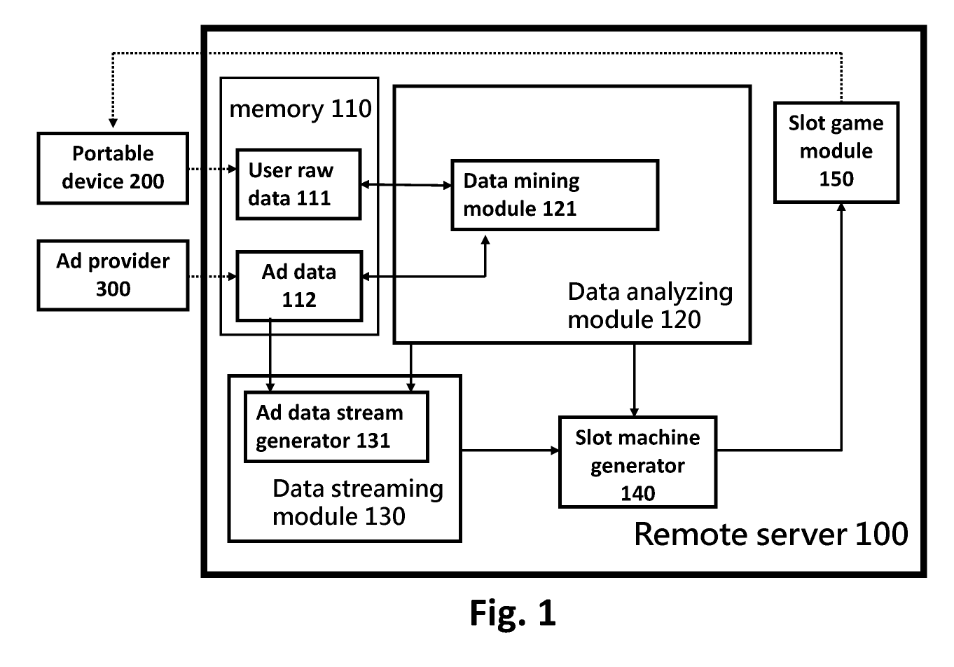

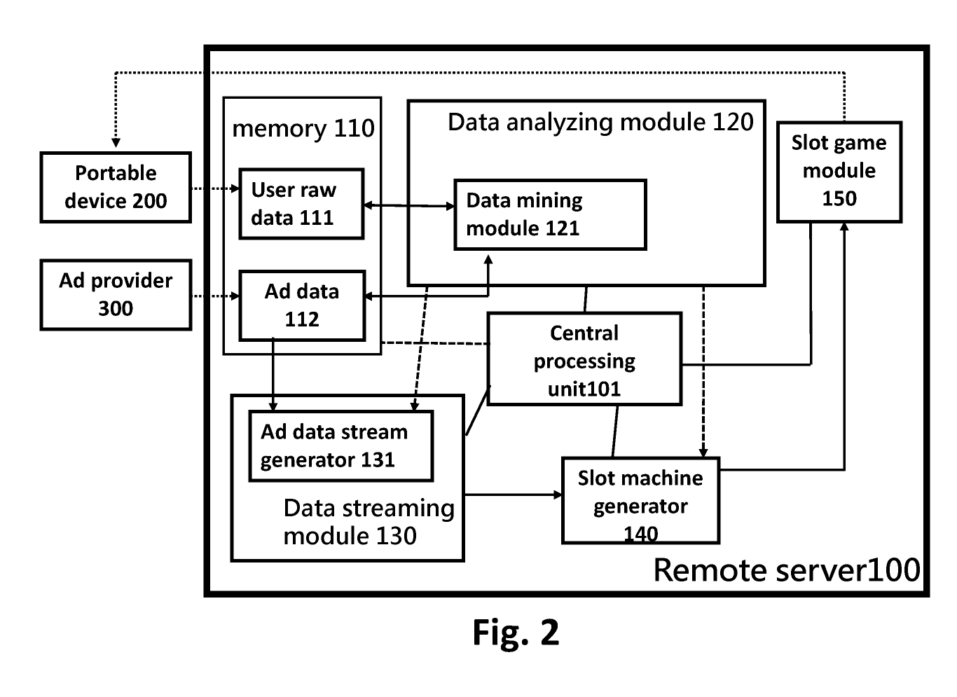

Please refer to FIG. 1, which illustrates a functional block diagram of a slot game system using advertisement data streaming of the present invention. The system includes at least one remote server 100, at least one portable device 200 and at least one advertisement provider 300. The remote server 100 may include a memory 110, a data analyzing module 120, a data streaming module 130, a slot machine generator 140 and a slot game module 150. In one embodiment, the memory 110 is coupled to the data analyzing module 120 and the data streaming module 130. In one embodiment, the slot machine generator 140 is also coupled to the data analyzing module 120 and the data streaming module 130. The slot machine generator 140 is coupled to the slot game module 150. The slot game module 150 is coupled to the portable device 200 to transmit the information data of the executed slot game to the portable device 200, so as to display the course and the outcome of the slot game via the display unit in the portable device 200. The data analyzing module 120 may include a data mining module 121 to extract useful patterns and relationships or knowledge from bulk data. The matching result between the user and the advertisement contents may be generated by the data mining module 121. Generally, the remote server 100 may include a central processing unit 101, wherein the memory 110, the data analyzing module 120, the data streaming module 130, the slot machine generator 140 and the slot game module 150 are electrically coupled to the central processing unit 101 as shown in FIG. 2.

Usually, in the system of the present invention, a plurality of portable devices 200 and a plurality of advertisement providers 300 provide the associated data of the individual user and individual advertisement data to the remote server 100 respectively. For example, the remote server 100 may receive or carry user raw data 111 and advertisement(Ad) data 112 respectively transmitted by a quite large number of portable devices 200 and advertisement providers 300. In one embodiment, the user raw data 111 and the advertisement data 112 may be stored in the memory 110 of the remote server 100. In one embodiment, the plurality of portable devices 200 may transmit the associated data of the user to the remote server 100 through wireless transmission or wireless communication method as shown in FIG. 1. For instance, the user raw data 111 may include gender, age, education level, consumption habit, consumer behavior, preference, interest, etc of the user while the advertisement data 112 may include the mark of a specific company, advertisement icon images, advertisement content images, which may indicate product advertisement, institutional advertisement or brand advertisement, etc.

In one embodiment, the data mining module 121 may include but be not limited to the following five functions or sub-modules: classification functions or sub-modules, estimation functions or sub-modules, prediction functions or sub-modules, affinity grouping functions or sub-modules and homogeneous clustering functions or sub-modules. For example, the classification functions/sub-modules may perform classification and perform definition according to the attributes of the analyzed subject to establish classes. For instance, the attributes of the mobile phone user may be classified as high-level economic capability user, medium-level economic capability user and low-level economic capability user. The used technique may include decision tree, memory-based reasoning, etc. The estimation functions or sub-modules obtain an unknown value of the attribute of a certain user according to the associated attribute data of the existing continuous values. For example, an appropriate advertisement types or advertisement amounts for the mobile phone user are estimated according to his/her education level and consumer behavior of the mobile phone user. The used technique may include the associated analysis of the statistical method, regression analysis and artificial neural network method, etc. The prediction functions or sub-modules predict the future values of the attribute according to the past observed values of the subject's attribute. For instance, the future consumption preferences, consumption types and consumption amounts of the mobile phone user are predicted based on his/her past consumption preferences, consumption types and consumption amounts. The used technique may include regression analysis, time series analysis and artificial neural network method, etc. The affinity grouping functions or sub-modules determine which associated advertisements in all advertisement symbols should be positioned together. For example, the symbols of the associated advertisements provided by a plurality of advertisement providers 300 to the remote server 100 are positioned in the same group to be chosen. In the system of the present invention, this function is employed to provide the advertisements in the same group to the data streaming module 130 so as to generate the same set of streaming data. The homogeneous clustering functions or sub-modules classify all of the advertisement databases provided by the advertisement provider 300 as more homogeneous clusters. Homogeneous clustering is equivalent to segmentation of the marketing term. It is assumed that the classification is not defined in advance and the classification occurs in the data naturally. The used technique may include k-means method and agglomeration method, etc.

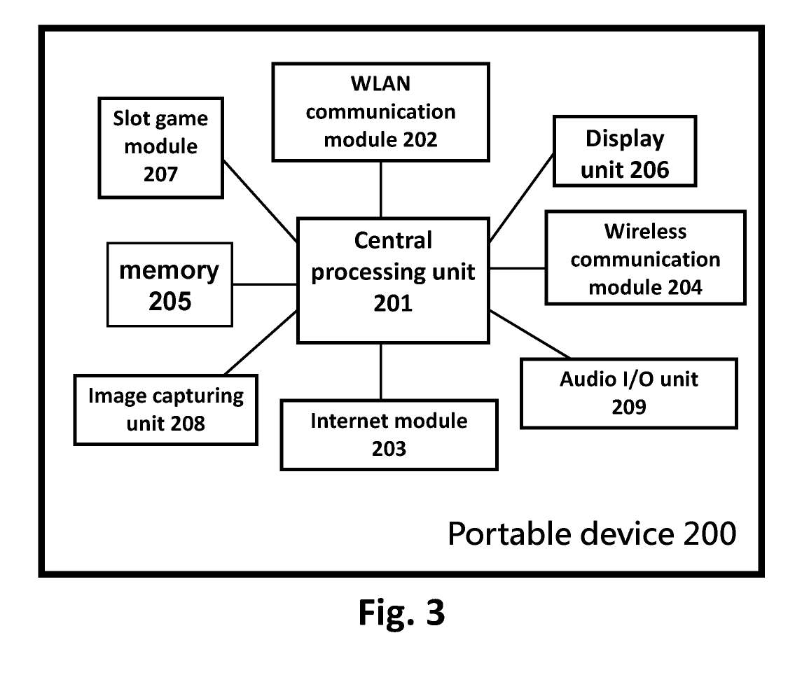

Please refer to FIG. 3, which illustrates a functional block diagram of the portable device of the present invention. FIG. 3 only shows or indicates important elements, and other elements which are not the technical features of the present invention are omitted. In this embodiment, the portable device 200 can transmit the user-related raw data to the remote server 100 through the wireless communication method and/or the Internet method. Namely, a wireless communication module 204, a wireless local area network (WLAN) communication module 202 and/or an internet module 203 may be employed to transmit the data. The portable device 200 may transmit or receive wireless audio signal or image signals via the internet module 203. The portable device 200 may include a SIM connector (not shown) to receive a SIM (subscriber identity module) card. The portable device 200 may include the wireless communication module 204 coupled to the central processing unit 201. For instance, the wireless communication module 204 may include a RF communication module, which may include an antenna to connect the signal receiving and emitting device. The signal receiving and emitting device may be utilized to receive or transmit signals. The RF communication module may also include a MODEM, a base band processing device, a down converter, a digital signal processor, etc, which are well known to the person having ordinary skill in the art. The RF communication module can process and be compatible to communication protocols of the mobile phone, which may include but be not limited to GSM, CDMA, PHS, etc. The received signals are processed by the RF communication module, are then transmitted to a CODEC to perform decoding, and are subsequently inputted to the digital-analog converter to be converted into the analog signals, so as to be transmitted to the audio input/output unit 209 to be output. On the contrary, the analog audio signals are inputted via the audio input/output unit 209 and are converted into digital signals by the signal-analog converter, are then encoded by the CODEC, and are emitted after being processed by the RF communication module. Furthermore, the wireless local area network communication module 202 is coupled to the central processing unit 201 and the CODEC.

The portable device 200 of the present invention may include the central processing unit/control IC 201 to control processing of signals and data, power control and processing of input and output signals. A slot game module 207, an operating unit (not shown), a built-in display unit 206, an operating system (not shown) and an image capturing unit 208 are electrically coupled to the control IC 201 respectively. The portable device 200 may also include a memory 205 coupled to the control IC 201 to store data and the operating system. Depending upon different attributes, the memory 205 may include ROM (read-only memory), RAM (random access memory), nonvolatile flash memory, etc. The RF communication module may process the reception of the signals, the processing of the base band, the processing of the digital signals, etc. The audio signals are transmitted to the output device such as the speaker/microphone unit. In general, unchanged data may be stored in Mask ROM while the system operating software or the application program may be generally stored in the nonvolatile memory. A wired input/output interface is coupled to the control IC 201 and may be USB, Fire wire or IEEE 1394 interface.

The wireless local area network (WLAN) communication module 202 is compatible to and may process the data transmission of the wireless local area network protocols. For example, the wireless local area network (WLAN) communication module 202 may be Bluetooth compatible module, Wi-Fi wireless transmission standard compatible module, 802.11x wireless transmission standard compatible module, WiMAX (Worldwide Interoperability for Microwave Access) wireless transmission standard compatible module. The portable device of the present invention can transmit or receive audio signals or image signals wirelessly and simultaneously by employing the WLAN communication module 202.

As mentioned above, the user can utilize the portable device 200 to transmit/input the user raw data to the remote server 100 via the wireless communication module 204, the WLAN communication module 202 and/or the internet module 203. In this embodiment, the user raw data 111 may include personal data, the user's preference or favor and any data which the user agrees to input. The user raw data 111 are for example stored in the memory 110 of the remote server 100. The advertisement provider 300 transmits/inputs the advertisement data 112 to the remote server 100. Similarly, the advertisement provider 300 can also transmit/input the advertisement data to the remote server 100 by utilizing the built-in wireless communication module, the WLAN communication module and/or the internet module. The advertisement provider 300 may for instance be a data transmitting end provided by the advertiser, provided by the advertiser entrusted by an enterprise or provided by a third party except the user, such as a server. The advertisement data 112 are for example be stored in the memory 110 of the remote server 100. The advertisement data 112 may include but be not limited to text, image, picture, video or the combination thereof.

After the user raw data 111 and the advertisement data 112 are inputted to the remote server 100, the user raw data 111 and the advertisement data 112 are stored in the memory 110. Subsequently, the user raw data 111 and the advertisement data 112 are inputted to the data analyzing module 120. The user raw data 111 and the advertisement data 112 are analyzed, compared, classified, predicted and estimated individually by employing the data mining module 121 of the data analyzing module 120 to generate appropriate or qualified users and advertisement symbols to be chosen. Then, the data mining module 121 outputs the chosen user and the chosen advertisement symbol respectively into the slot machine generator 140 and the data streaming module 130. The data mining module 121 still needs to request the user to provide modified or new user raw data 111 at any time because the user of the portable device 200 might update his/her basic data or personal data at different time or under different situations. Moreover, the data mining module 121 still needs to request the advertisement provider 300 to provide modified or new advertisement data 112 at any time because the advertisement provider 300 may also modify the advertisement contents at different time or under different situations. The aforementioned action of request may be executed by the data mining module 121 or by the central processing unit 101.

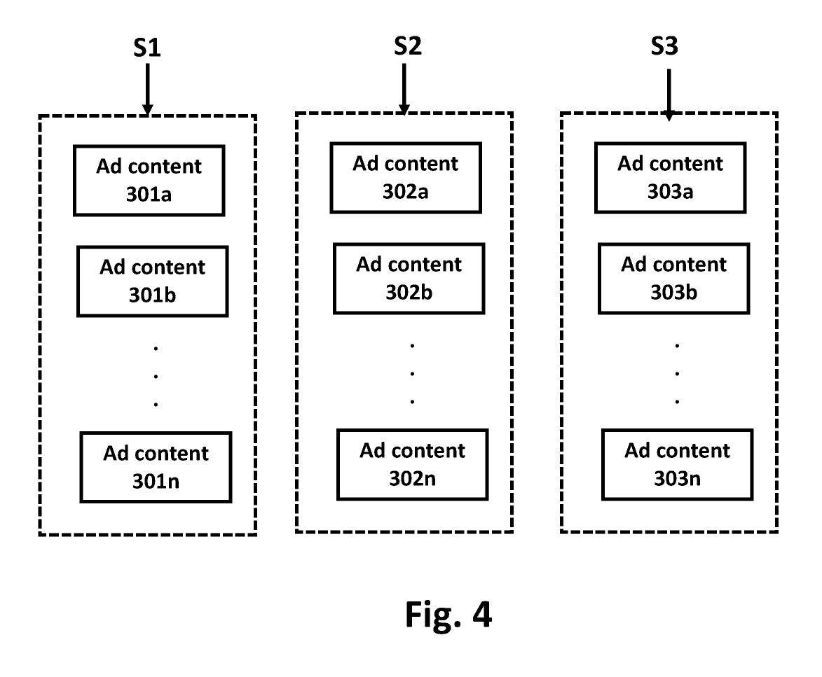

Subsequently, the data mining module 121 transmits the message of a series of inputted advertisement symbols which are chosen to the data streaming module 130. After the data streaming module 130 receives the message, the chosen advertisement symbols are requested to be inputted from the memory 110 to the data streaming module 130. The aforementioned action of request may be executed by the data streaming module 130 or by the central processing unit 101. Then, the advertisement data streaming generator 131 performs streaming to the chosen advertisement symbols to generate multiple sets of streaming advertisement symbols, such as n sets of streaming advertisement symbols S1, S2, S3 . . . Sm. The multiple sets of streaming advertisement symbols are transmitted to the slot machine generator 140. For example, each streaming advertisement symbol may include a plurality of different advertisement symbols (such as similar advertisement symbols or dissimilar advertisement symbols). FIG. 4 includes three streaming advertisement symbols S1, S2 and S3, wherein the streaming advertisement symbol S1 includes n advertisement contents, such as advertisement content 301a, 301b, . . . , 301n, the streaming advertisement symbol S2 includes n advertisement contents, such as advertisement content 302a, 302b, . . . , 302n, and the streaming advertisement symbol S3 includes n advertisement contents, such as advertisement content 303a, 303b, . . . , 303n, wherein the number of n may be set arbitrarily. In one embodiment, the advertisement symbol may include the combination of the advertisement picture and the common picture.

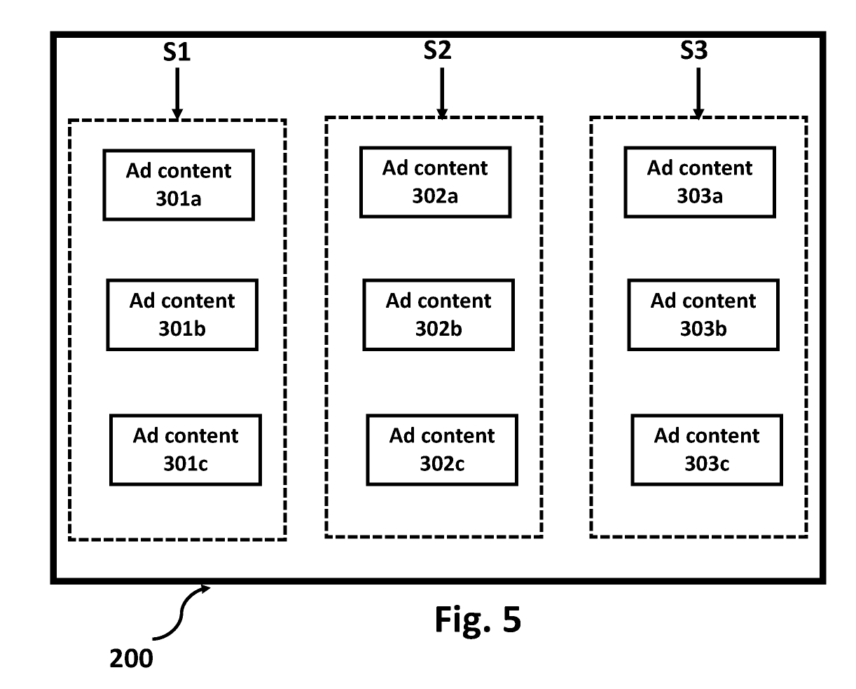

Subsequently, the selected users are matched with the multiple sets of streaming advertisement symbols in the slot machine generator 140 according to the selected users output by the data mining module 121 to the slot machine generator 140 and the multiple sets of streaming advertisement symbols output by the data streaming module 130 to the slot machine generator 140 to generate the streaming advertisement symbols needed by a slot machine game. The constituting elements of the slot game are the matched streaming advertisement symbols. Each user is assigned a plurality of matched streaming advertisement symbols for the subsequent slot game. The game rules of the slot game are defined in the slot game module 150. That is to say, the number of the streaming advertisement symbols and the number of the advertisement symbols of each streaming advertisement symbol are pre-defined in the slot game. In other words, the game rules of the slot game module 150 are combined with the slot machine generator 140, such that the slot game may be performed or displayed in the portable device 200. For instance, in an example in FIG. 4, the user of a certain portable device 200 is assigned three streaming advertisement symbols S1, S2 and S3 to prepare for forming a slot game. Then, after the matching is complete, the slot machine generator 140 outputs the data of the matched user of the portable device 200 and the matched streaming advertisement symbols to the slot game module 150, so as to perform the slot game in the slot game module 150. In one embodiment, the slot game may be performed in the slot game module 150 of the remote server 100. In another embodiment, the slot game may be performed in the slot game module 207 of the portable device 200. Furthermore, the display unit of the portable device 200 may display the process and the outcome of the slot game in the slot game module 150 because the slot game module 150 of the server is coupled to the slot game module 207 of the portable device 200. In the example of FIG. 5, the display unit of the portable device 200 may display the outcome of the slot game of three streaming advertisement symbols S1, S2 and S3. Finally, the three advertisement contents 301a, 301b, 301c are shown in the steaming advertisement symbol S1, the three advertisement contents 302a, 302b, 302c are shown in the steaming advertisement symbol S2, and the three advertisement contents 303a, 303b, 303c are shown in the steaming advertisement symbol S3.

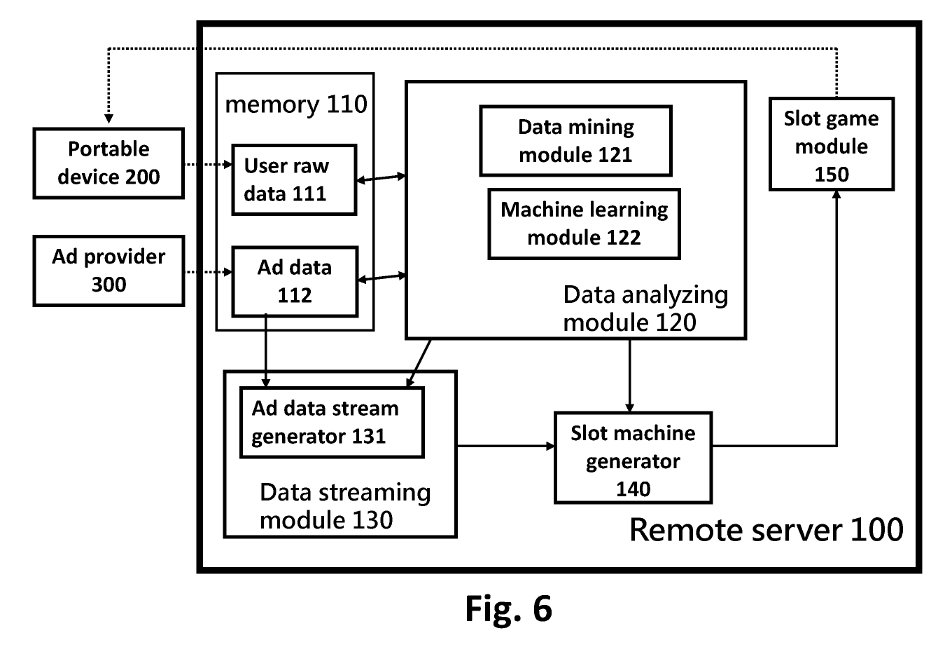

Please refer to FIG. 6, which illustrates a functional block diagram of the slot game system using the advertisement data streaming in accordance with another embodiment of the present invention. In this embodiment, the data analyzing module 120 may include the data mining module 121 and machine learning module 122. The machine learning module 122 mainly combines the pattern recognition with the computational learning method, so as to assist the data mining module 121.

In the present invention, the data streaming module 130 transforms the advertisement symbols into the streaming advertisement symbols to be provided to the selected user. The slot machine generator 140 can generate a slot game through the input of selected users and streaming advertisement symbols, and the slot game may be transmitted to the portable device or the client device 200 of the selected user. The portable device may for instance be smart phone, tablet PC, etc. The client device may for example be personal computer, etc. The portable device or the client device 200 feeds the data into the data analyzing module 120 and the slot machine generator 140, such that the interactive procedures may be performed.

It should be appreciated that the embodiments described herein are described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof

What is claimed is:

1. An advertisement system applicable for multiple portable devices, comprising:
an advertisement remote server coupled to said multiple portable devices, wherein each of said multiple portable devices having a first wireless transmission module and first internet module;
wherein said advertisement remote server includes a second wireless transmission module, a second internet module, a data analyzing module, a data streaming module and a slot machine generator;
wherein multiple user raw data are transmitted by said first wireless transmission modules or said first internet modules of each said multiple portable devices to said second wireless transmission module or said second internet module of said advertisement remote server;
wherein multiple advertisement data are transmitted by a plurality of advertisement data transmitting terminals to said advertisement remote server;
wherein said data analyzing module is used to generate selected users, said data streaming module is used to generate a plurality of groups of under-streaming advertisement data, and said slot machine generator is used to match said selected users with said plurality of groups of under-streaming advertisement data such that each of said selected users corresponds at least one group of under-streaming advertisement data;
wherein said each of said multiple portable devices displays streaming data of said at least one group of under-streaming advertisement data on a display unit.

2. The system of claim 1, wherein each of said multiple portable devices is a smart phone.

3. The system of claim 1, wherein said plurality of groups of under-streaming advertisement data include multiple sets of streaming advertisement symbols.

4. The system of claim 1, wherein said advertisement remote server further includes a slot game module for streaming data of said at least one group of under-streaming advertisement data.

5. The system of claim 4, wherein said each of multiple portable devices includes a second slot game module for streaming data of said at least one group of under-streaming advertisement data.

6. The system of claim 1, wherein said data analyzing module comprises a prediction module to predict future values of a user's attribute according to past observing values of said user's attribute.

7. The system of claim 1, wherein said data analyzing module comprises an affinity grouping module to determine which advertisement data are positioned in a same group in said plurality of group of under-streaming advertisement data.

8. The system of claim 7, wherein each of said multiple portable devices is a smart phone.

9. The system of claim 1, wherein said advertisement remote server further comprises a memory to store said multiple user raw data.

10. The system of claim 9, wherein said multiple advertisement data are stored in said memory.

11. The system of claim 9, wherein said multiple advertisement data are inputted from said memory to said data streaming module.

12. The system of claim 1, wherein said data analyzing module comprises an estimation module to obtain an estimation value according to associated attribute data of existing values of said user's attribute.

13. The system of claim 12, wherein each of said multiple portable devices is a smart phone.

14. The system of claim 12, wherein said plurality of groups of under-streaming advertisement data include multiple sets of streaming advertisement symbols.

15. The system of claim 12, wherein said advertisement remote server further includes a slot game module for streaming data of said at least one group of under-streaming advertisement data.

16. The system of claim 15, wherein said each of multiple portable devices includes a second slot game module for streaming data of said at least one group of under-streaming advertisement data.
